(19) United States
(12) Patent Application Publication
(10) Pub. No.: US 2020/0240386 A1
(43) Pub. Date: Jul. 30, 2020

(54) TOWER FOR HYDROPOWER

(71) Applicant: Chien-Chen Yang, New Taipei City (TW)

(72) Inventor: Chien-Chen Yang, New Taipei City (TW)

(21) Appl. No.: 16/260,133

(22) Filed: Jan. 29, 2019

(51) Int. Cl. F03B 7/00; F03B 13/08

(52) U.S. Cl. CPC F03B 7/006; F03B 13/08; F03B 7/003

(57) ABSTRACT

The present invention teaches a tower for hydropower, comprising a main structure comprising an outflow tank at a top end and a collection tank at a bottom end of the main structure; a transmission device configured in the main structure; a plurality of water basins configured on the transmission device;

and a generator device is coupled to the transmission device. Water is introduced into an outflow tank, and then into water basins so that the water basins are pulled downward by gravity so as to convert potential energy into kinetic energy that drives a transmission device and a generator device to produce electrical energy. Through this simple tower, a limited amount of water is used for electricity generation of enhanced efficiency, with fast initiation and low operating reserve.

### BACKGROUND OF THE INVENTION

### (a) Technical Field of the Invention

The present invention is generally related to hydropower, and more particular to a tower for hydropower generation with enhanced efficiency.

### (b) Description of the Prior Art

Most hydroelectric power is from harnessing the potential energy of dammed water driving a water turbine and generator located around the bottom of the dam. The power extracted from the water depends on the volume and on the difference in height between the source and the water's outflow. This conventional hydroelectric mechanism requires a large volume of water and the water is usually utilized only once, resulting in a limited power generation efficiency.

### SUMMARY OF THE INVENTION

A major objective of the present invention is to teach a tower for hydropower where water is introduced into an outflow tank, and then into water basins so that the water basins are pulled downward by gravity so as to convert potential energy into kinetic energy that drives a transmission device and a generator device to produce electrical energy. Through this simple tower, a limited amount of water is used for electricity generation of enhanced efficiency, with fast initiation and low operating reserve.

To achieve the objective, the present invention teaches a tower for hydropower, comprising a main structure comprising an outflow tank at a top end and a collection tank at a bottom end of the main structure; a transmission device configured in the main structure; a plurality of water basins configured on the transmission device; and a generator device is coupled to the transmission device.

The main structure further comprises a plurality of vertical columns, a plurality of lateral beams between the columns, a plurality of support beams between the beams, and a plurality of vertical tracks on the support beams; and the water basins are supported from a back side by the tracks.

The outflow tank has an outlet pointing downward at a water basin moved beneath; the outflow tank has a top cover with at least an inlet on a lateral side.

The collection tank has at least an outlet on a lateral side.

The transmission device comprises a first transmission unit adjacent and beneath the outflow tank, a second transmission unit adjacent and above the collection tank, and a plurality of chain elements that loop around the first transmission unit and the second transmission unit; and each water basin is joined to the chain elements.

The first transmission unit comprises two oppositely positioned first bearing seats, a first axle rotatably held by the first bearing seats, and a plurality of first gears threaded by the first axle.

The second transmission unit comprises two oppositely positioned second bearing seats, a second axle rotatably held by the second bearing seats, and a plurality of second gears threaded by the second axle; and an adjustment unit is configured on each second bearing seat.

Each chain element comprises a plurality of first link elements and a plurality of second link elements end-to-end connected together; each chain element loops around a first gear and a second gear; each chain element has its first link elements and second link elements movably confined in a track; each water basin is joined to first link elements.

Each first link element comprises a plurality of first links, two first plates fixed to two lateral sides of one of the first links, two first extensions extended backward from the first plates , and two first rollers rotatably mounted on the two first extensions; each first plate has a plurality of through holes for joining with a water basin; and the first rollers are confined in a track.

Each second link element comprises a plurality of second links, two second plates fixed to two lateral sides of one of the second links, two second extensions extended backward from the second plates, and two second rollers rotatably mounted on the two second extensions; each second plate has a through hole; and the second plates provide support against a water basin; and the second rollers are confined in a track.

Reinforced plates are disposed around a top opening, and pins for locking through holes of the second plates are disposed on a back side of the of each water basin.

The generator device comprises a casing to a side of the main structure, a gear unit inside the casing coupled to the first axle of the transmission device, and a generator inside the casing coupled to the gear unit.

The main structure further comprises a staircase to a side of the main structure reaching from ground up to the generator device.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a tower for hydropower according to an embodiment of the present invention.

FIG. 2 is another perspective diagram showing the tower for hydropower of FIG. 1.

FIG. 3 is a partially enlarged diagram showing a lower part of the tower for hydropower of FIG. 1.

FIG. 4 is a partially enlarged diagram showing a lower part of the tower for hydropower of FIG. 1.

FIG. 5 is a perspective diagram showing a first link element of the tower for hydropower of FIG. 1.

FIG. 6 is a perspective diagram showing a second link element of the tower for hydropower of FIG. 1.

FIG. 7 is a perspective diagram showing a water basin jointed to first link elements and supported by second link elements of the tower for hydropower of FIG. 1.

FIG. 8 is another perspective diagram showing a water basin jointed to first link elements and supported by second link elements of the tower for hydropower of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

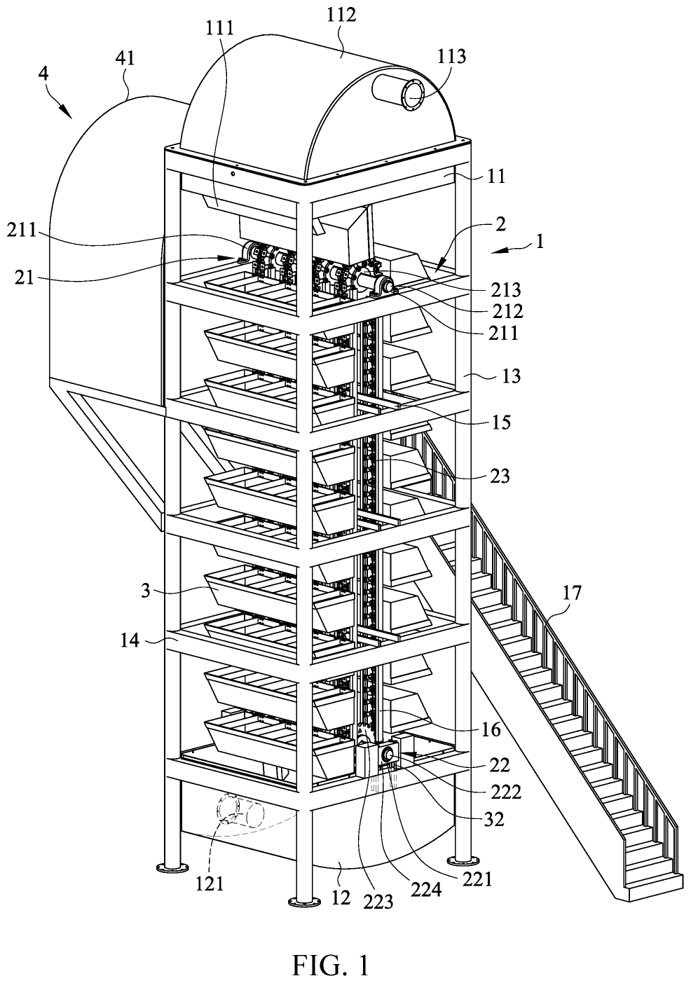

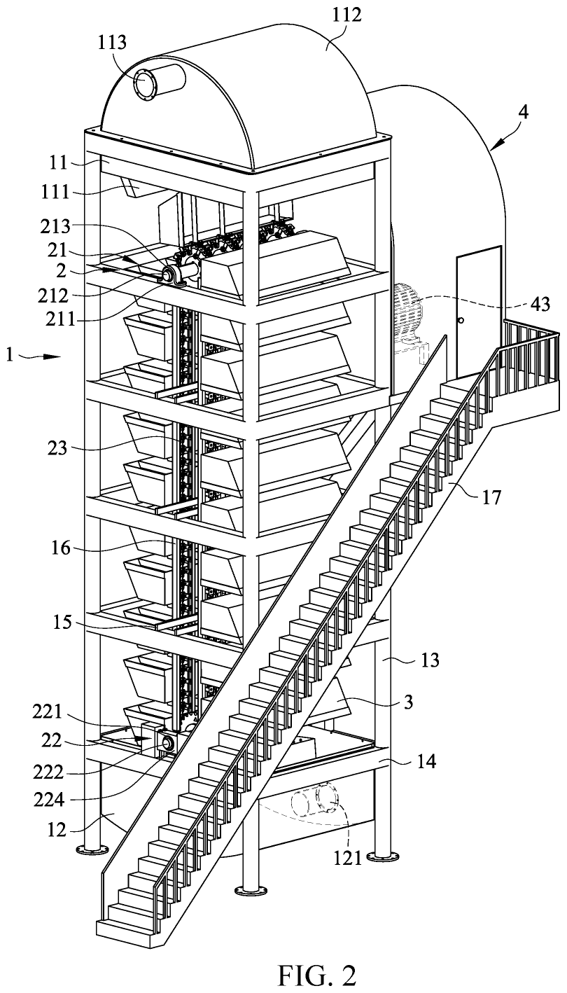

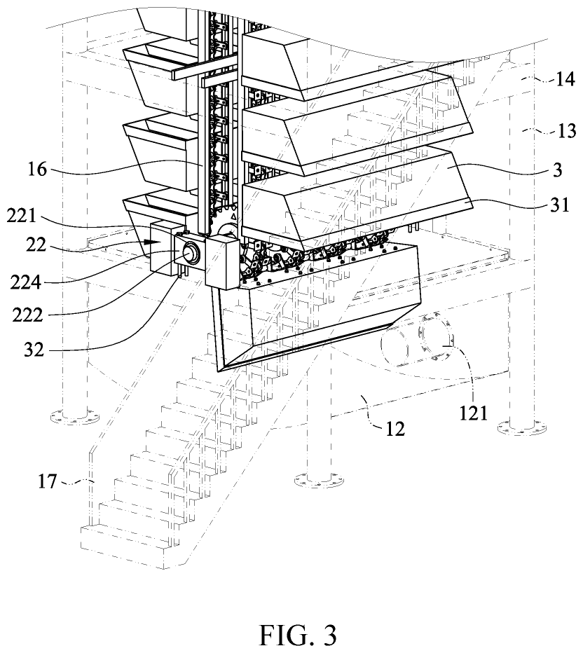

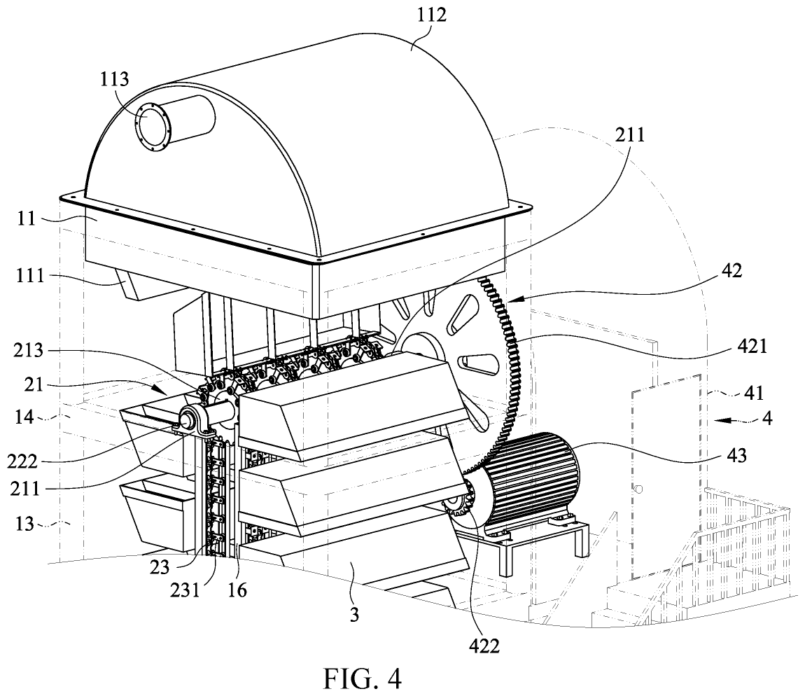

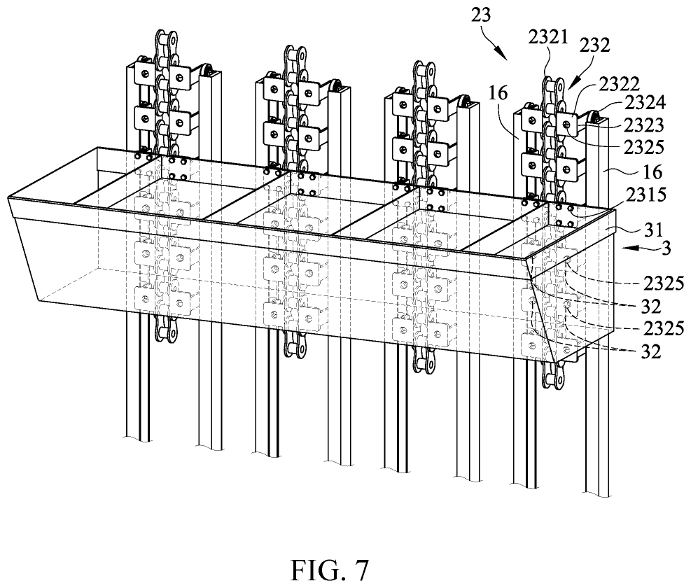

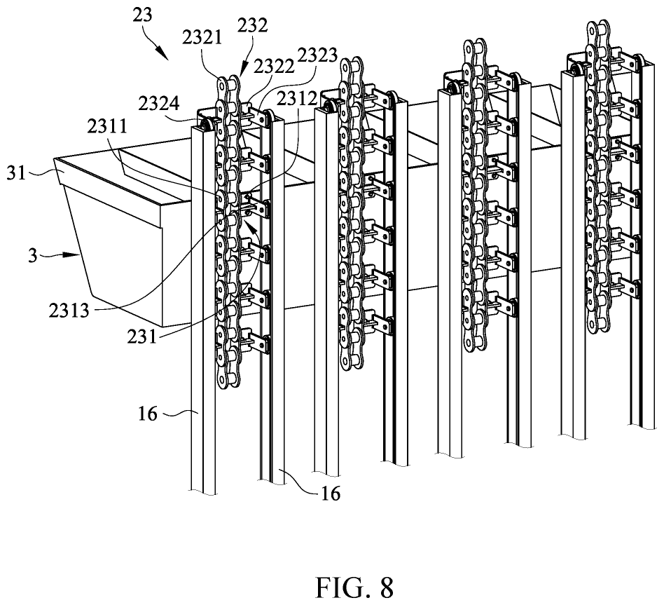

As shown in FIGS. 1 to 8, a tower for hydropower according to an embodiment of the present invention includes a main structure 1, a transmission device 2, a number of water basins 3, and a generator device 4.

The main structure 1 has an outflow tank 11 at a top end and a collection tank 12 at a bottom end of the main structure 1.

The transmission device 2 is configured in the main structure 1.

The water basins 3 are configured on and driven by the transmission device 2.

The generator device 4 is coupled to the transmission device 2. As described so far, these elements jointly form the tower for hydropower.

The tower for hydropower is operated as follows. The main structure 1 is constructed besides and lower than a river, creek, or dam. Water is then introduced into the outflow tank 11 through a pipe. The water may contain impurities, particles, or even mud, and the tower's power generation is not affected. Water from the outflow tank 11 is then poured into water basins 3 so that they are pulled downward by gravitation, which in turn engages the transmission device 2. Empty water basins are thereby moved below the outflow tank 11 to receive water. As such, gravitation continuously pulls downward the filled water basins 3 and the transmission device 2 continuously spins to provide empty water basins 3. For example, if a water basin 3 may hold a ton of water, 10 water basins 3 would hold 10 tons of water. As such, the potential energy of the water constantly drives the transmission device 2 to produce a mechanical energy by a 10-ton torque. The mechanical energy of the transmission device 2 is then converted to electrical power by the generator device 4. The filled water basins 3, as they move toward the bottom end of the main structure 1, pour their water into the collection tank 12. The water in the collection tank 12 is then expelled or piped to another tower for hydropower of the present invention. As such, the present invention is able to achieve power generation of high efficiency consuming a limited amount of water. The tower may be quickly turned on for power generation and, therefore, may reduce the amount of operating reserve.

Assuming that the tower for hydropower is 10-meter high and that each water basin 3 takes one-ton of water in one second, thereby producing a 10-ton torque, 10 water basins 3 may initiate the generator device 4 in 10 seconds Similarly, a 30-meter tower may initiate the generator device 4 in 30 seconds, as 30-ton torque is produced by a ton of water in one second.

In addition, multiple towers of the present invention may be disposed along the slope of a mountain. The water from a highest tower is piped from its collection tank 12 to the outflow tank 11 of a next tower, and so on. Therefore, for 100 towers of the present invention arranged in this manner, they would produce electricity 100 times greater. If the water is muddy, due to the weight of the mud, each tower would produce 1.5 times of electricity than when the water is clear. The towers of the present invention therefore would be best for mountainous areas. As mudflows often occur on mountains and check dams are built to prevent mudflows, the collected mudflows may be utilized for power generation through the tower of the present invention. The mudflows then may be directed to detention ponds for gravity separation and the water may be further utilized Similarly, the towers of the present invention may also be built along river banks besides check dams. The mudflows may be collected to the detention ponds and diverted to the towers of the present invention. The water after power generation may be further utilized for irrigation. As such, the tower of the present invention provides not only power generation but also functions such as flood control, water regulation, irrigation, etc.

In one embodiment, the main structure 1 includes multiple vertical columns 13, multiple lateral beams 14 between the columns 13, multiple support beams 15 between the beams 14, and multiple vertical tracks 16 on the support beams 15. In other words, the main structure 1 is constructed by assembling the columns 13 and the beams 14, and is reinforced by the support beams 15 and tracks 16. The tracks 16 laterally support the water basins 3 when they are filled with water.

In one embodiment, the outflow tank 11 has an outlet 111 pointing downward at a water basin 3 moved beneath. The outflow tank 11 has a top cover 112 with at least an inlet 113 on a lateral side. The collection tank 12 also has at least an outlet 121 on a lateral side. As such, water is introduced into the outflow tank 11 through the inlet 113 by a pipe. Water is then injected into the water basins 3 sequentially moved beneath through the outlet 111. When a water basin 3 is moved to a lowest point of the main structure 1, water is collected by the collection tank 12 and expelled from the outlet 121.

In one embodiment, the transmission device 2 includes a first transmission unit 21 adjacent and beneath the outflow tank 11, a second transmission unit 22 adjacent and above the collection tank 12, and multiple chain elements 23 that loop around the first transmission unit 21 and the second transmission unit 22. Each water basin 3 is joined to the chain elements 23. The first transmission unit 21 includes two oppositely positioned first bearing seats 211, a first axle 212 rotatably held by the first bearing seats 211, and multiple first gears 213 threaded by the first axle 212. The second transmission unit 22 includes two oppositely positioned second bearing seats 221, a second axle 222 rotatably held by the second bearing seats 221, and multiple second gears 223 threaded by the second axle 222. An adjustment unit 224 is configured on each second bearing seat 221.

As the water basins 3 move downward due to gravity, the chain elements 23 turns and drives the first gears 213 and the second gears 223 on the first and second axles 212 and 222 to spin. The water basins 3 are thereby moved continuously in circles. For 10-ton force exerted on the first axle 212 and the second axle 222, they will produce 10-ton torque. Together with the first gears 213 and the second gears 223 that spin 2.2 rounds per second, the generator device 4 is able to produce electricity at the highest efficiency at this ideal spinning speed.

In addition, the adjustment units 224 may be used to raise or lower the second axle 222 so as to tighten or relax the chain elements 23.

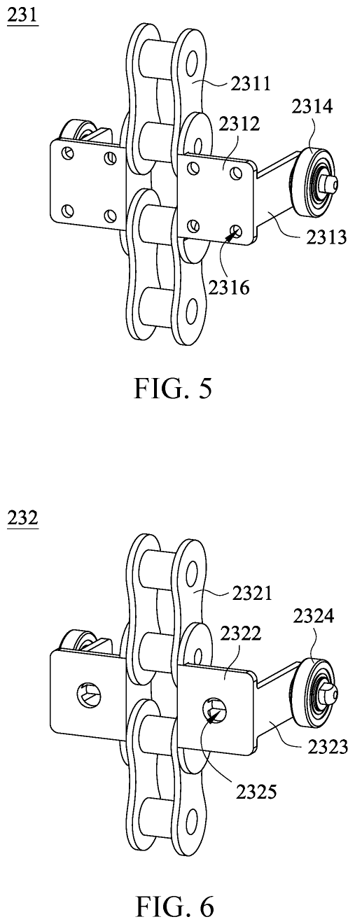

In one embodiment, each chain element 23, as shown in FIGS. 5 to 8, includes multiple first link elements 231 and multiple second link elements 232 end-to-end connected together. Each chain element 23 has its first link elements 231 and second link elements 232 movably confined in a track 16. Each water basin 3 is joined to first link elements 231. Each first link element 231 includes a number of first links 2311, two first plates 2312 fixed to two lateral sides of one of the first links 2311, two first extensions 2313 extended backward from the first plates 2312, and two first rollers 2314 rotatably mounted on the two first extensions 2313. Each first plate 2312 has a number of through holes 2316 for joining with a water basin 3 by applying a number fasteners 2315. The first rollers 2314 are confined in a track 16. Each second link element 232 includes a number of second links 2321, two second plates 2322 fixed to two lateral sides of one of the second links 2321, two second extensions 2323 extended backward from the second plates 2312, and two second rollers 2324 rotatably mounted on the two second extensions 2323. Each second plate 2322 has a through hole 2325. The second plates 2322 provide support against a water basin 3. The second rollers 2324 are confined in a track 16. Each chain element 23 loops around a first gear 213 and a second gear 223 and engages them through the first links 2311and the second links 2321.

As the water basins 3 move downward due to gravity, the chain elements 23 have their first rollers 2314 and second rollers 2324 of the first link elements 231and the second link elements 232 moved along the tracks 16. Through the joint effect of the tracks 16, the first extensions 2313, the first rollers 2314, the second extensions 2323, and the second rollers 2324 of the first link elements 231and the second link elements 232, the water basins 3 are moved steadily and reliably. Furthermore, the chain elements 23 are able to prevent twist and deformation to the water basins 3.

When the second axle 222 is raised upward or lowered downward by the adjustment units 224, the extension and tightness between the first links 2311 and second links 2321 of each chain element 23 is adjusted.

In one embodiment, reinforced plates 31 are disposed around a top opening, and pins 32 for locking through holes 2325 of the second plates 2322 are disposed on a back side of the of each water basin 3. When the water basins 3 are fully filled with water, the reinforced plates 31 prevent the water basins 3 from deformation. In addition, other than the joint effect of the tracks 16, the first extensions 2313, the first rollers 2314, the second extensions 2323, and the second rollers 2324 of the first link elements 231and the second link elements 232 so that the water basins 3 are moved steadily and reliably, the weight of the water basins 3 is further supported as the water basins 3 are against the second plates 2322 of the second link elements 232, with the pins 32 coupling the through holes 2325.

In an embodiment of the present invention, the generator device 4 has a casing 41 to a side of the main structure 1, a gear unit 42 inside the casing 41 coupled to the first axle 212 of the transmission device 2, and a generator 43 inside the casing 41 coupled to the gear unit 42. The casing 41 protects the gear unit 42 and the generator 43 inside. The gear unit 42 may include a set of engaging big gear 421 and small gear 422, or other similar mechanism. The gear unit 42 is configured so that, through its speed change, the generator 43 may attain a highest efficiency from the first gears 213 and the second gears 223 at 2.2 rounds per second (i.e., 27.27 rounds per minute) under a gear ratio 1:6 (thereby achieving 1636 rounds per minute and delivering a torque 166 Kg).

In one embodiment, the main structure 1 further includes a staircase 17 to a side of the main structure reaching from ground up to the generator device 4 so that personnel may conduct maintenance on the main structure 1, the transmission device 2, the water basins 3, and the generator device 4.

The various features of the present invention are as follows.

1. A limited amount of water is applied to achieve highly efficient power generation regardless of whether debris, particles, and mud are included in the water.

2. The tower of the present invention has the water basins 3 arranged in multiple layers and the width of each water basin 3 may be extended to increase its weight and the pull of gravity, thereby increasing the torque to the generator device 4 and the volume of generated power. The towers may be cascaded to provide even greater power generation. For example, 22 water basins 3 are configured around the transmission device 2 and each may hold a ton of water. 10 of the water basins 3 would be effectively pulled by gravity. If a ton of water per second is filled in a first water basin 3, the water would be flown to a second water basin 3, until all 10 water basins 3 are filled. The gravity then pulls the water basins 3 and the chain elements 23 attached to the water basins 3 are turned. The first gears 213 and the second gears 223 spin and the water basins 3 reaching the lowest level pour their water out. As such, by providing a ton of water per second from above, the water basins 3 would continuously move around within the main structure 1. As the first gears 213 and the second gears 223 of the first axle 212 and the second axle 222 are exerted 10-ton force, the first axle 212 and the second axle 222 produce 10-ton torque. The gears make a turn every 2.2 seconds (i.e., 27.27 round per minute) and, through the gear unit 42's 1:60 gear ratio, the axles spin 1636 rounds per minute and produce a torque of 166 Kg to drive the generator 43 at an ideal speed so that the generator 43 achieves a highest power generation efficiency.

3. Multiple towers of the present invention may be disposed along the slope of a mountain. The water from a highest tower is piped to a next tower, and so on. Therefore, for 100 towers of the present invention arranged in this manner, they would produce electricity 100 times greater. If the water is muddy, due to the weight of the mud, each tower would produce 1.5 times of electricity than when the water is clear. The towers of the present invention therefore would be ideal for mountainous areas.

4. The tower of the present invention may be initiated to produce electricity in 3 minutes. For conventional power generation using nuclear, wind, or coal, their power generators take a longer time to start and therefore 15% of operating reserve is prepared. As such, a significantly less operating reserve would be required for the present invention, thereby achieving significant energy saving and power generation efficiency.

5. The tower of the present invention provides additional functions such as flood control, water regulation, irrigation, etc. As mudflows often occur on mountains and check dams are built to prevent mudflows, the collected mudflows may be utilized for power generation through the tower of the present invention. The mudflows then may be directed to detention ponds for gravity separation and the water may be further utilized. Alternatively, the mud water may be used for artificial wetland, or expelled directly into ocean.

The tower of the present invention may be applied as follows.

1. Mud cleared from a dam may be utilized by the present invention to generate power. The mud is usually heavier than water (1.5:1) and therefore may achieve a greater efficiency than that produced by clear water. For a mountain of height 1000 meters, a ton of water may produce a 1,000-ton torque for power generation. A ton of mud water may produce 1500-ton of torque, thereby achieving 1.5 times of power generation.

2. Water after being used for conventional hydropower generation may be further utilized by the tower of the present invention so that water resource may be repeatedly utilized.

3. Water for people's livelihood may be first applied to a tower of the present invention for power generation before it is piped to households.

4. Water for irrigation may be first applied to a tower of the present invention for power generation before it is piped to the fields.

5. Water for industry may be first applied to a tower of the present invention for power generation before it is piped to the factories.

6. Water discharged from a dam may be applied to a tower of the present invention for power generation.

7. The tower of the present invention may be driven by clear water, rain water, water with impurities, water with particles, muddy water, etc.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A tower for hydropower, comprising:
a main structure comprising an outflow tank at a top end and a collection tank at a bottom end of the main structure;
a transmission device configured in the main structure;
a plurality of water basins configured on the transmission device; and
a generator device is coupled to the transmission device.

2. The tower according to claim 1, wherein the main structure further comprises a plurality of vertical columns, a plurality of lateral beams between the columns, a plurality of support beams between the beams, and a plurality of vertical tracks on the support beams; and the water basins are supported from a back side by the tracks.

3. The tower according to claim 1, wherein the outflow tank has an outlet pointing downward at a water basin moved beneath; the outflow tank has a top cover with at least an inlet on a lateral side.

4. The tower according to claim 1, wherein the collection tank has at least an outlet on a lateral side.

5. The tower according to claim 2, wherein the transmission device comprises a first transmission unit adjacent and beneath the outflow tank, a second transmission unit adjacent and above the collection tank, and a plurality of chain elements that loop around the first transmission unit and the second transmission unit; and each water basin is joined to the chain elements.

6. The tower according to claim 5, wherein the first transmission unit comprises two oppositely positioned first bearing seats, a first axle rotatably held by the first bearing seats, and a plurality of first gears threaded by the first axle.

7. The tower according to claim 6, wherein the second transmission unit comprises two oppositely positioned second bearing seats, a second axle rotatably held by the second bearing seats, and a plurality of second gears threaded by the second axle; and an adjustment unit is configured on each second bearing seat.

8. The tower according to claim 7, wherein each chain element comprises a plurality of first link elements and a plurality of second link elements end-to-end connected together; each chain element loops around a first gear and a second gear; each chain element has its first link elements and second link elements movably confined in a track; each water basin is joined to first link elements.

9. The tower according to claim 8, wherein each first link element comprises a plurality of first links, two first plates fixed to two lateral sides of one of the first links, two first extensions extended backward from the first plates, and two first rollers rotatably mounted on the two first extensions; each first plate has a plurality of through holes for joining with a water basin; and the first rollers are confined in a track.

10. The tower according to claim 9, wherein each second link element comprises a plurality of second links, two second plates fixed to two lateral sides of one of the second links, two second extensions extended backward from the second plates, and two second rollers rotatably mounted on the two second extensions; each second plate has a through hole; and the second plates provide support against a water basin; and the second rollers are confined in a track.

11. The tower according to claim 10, wherein reinforced plates are disposed around a top opening, and pins for locking through holes of the second plates are disposed on a back side of the of each water basin.

12. The tower according to claim 1, wherein the generator device comprises a casing to a side of the main structure, a gear unit inside the casing coupled to the first axle of the transmission device, and a generator inside the casing coupled to the gear unit.

13. The tower according to claim 1, wherein the main structure further comprises a staircase to a side of the main structure reaching from ground up to the generator device.
